(19) United States
(12) Patent Application Publication
(10) Pub. No.: US 2023/0267706 A1
(43) Pub. Date: Aug. 24, 2023

(54) VIDEO REMASTERING VIA DEEP LEARNING

(71) Applicant: DISNEY ENTERPRISES, INC., Burbank, CA (US)

(72) Inventors: Abdelaziz DJELOUAH, Zurich (CH); Shinobu HATTORI, Los Angeles, CA (US); Christopher Richard SCHROERS, Uster (CH); Andrew John WAHLQUIST, Stratford (CA)

(21) Appl. No.: 18/172,201

(22) Filed: Feb. 21, 2023

Related U.S. Application Data
(60) Provisional application No. 63/312,341, filed on Feb. 21, 2022.

(51) Int. Cl. G06V 10/771; G06T 3/00; G06T 3/40; G06T 5/10; G06V 10/24

(52) U.S. Cl. CPC G06V 10/771; G06T 3/0006; G06T 3/40; G06T 5/10; G06V 10/24; G06T 2207/20056; G06T 2207/20081; G06T 2207/30168

(57) ABSTRACT

One embodiment of the present invention sets forth a technique for performing remastering of video content. The technique includes determining a first input frame corresponding to a first frame included in a first video and a first target frame corresponding to a second frame included in a second video based on one or more alignments between the first frame and the second frame. The technique also includes executing a machine learning model to convert the first input frame into a first output frame. The technique further includes training the machine learning model based on one or more losses associated with the first output frame and the first target frame.

### CROSS-REFERENCE TO RELATED APPLICATIONS

This application claims the benefit of the U.S. Provisional Application titled “Training Deep Remastering Models,” filed on Feb. 21, 2022, and having Ser. No. 63/312,341. The subject matter of this application is hereby incorporated herein by reference in its entirety.

### BACKGROUND

### Field of the Various Embodiments

Embodiments of the present disclosure relate generally to video remastering and, more specifically, to video remastering via deep learning.

### Description of the Related Art

Video remastering is the process of changing or improving the quality of a video. For example, video remastering can involve adjusting the color, brightness, contrast, and saturation of a video; reducing noise and graininess in the video; improving the sharpness or resolution of the video; and/or repairing damaged or degraded video.

Video remastering techniques are commonly used to convert older “legacy” content that is captured on film into high-resolution digital formats that are suitable for streaming or playback on a laptop computer, smart television, tablet computer, or other type of electronic device. For example, a master copy of an episode of a television show could be stored on a film reel. The episode could be remastered into a digital copy by scanning the film reel using a modern scanning device. The resulting scanned version of the episode could have a higher resolution, higher visual quality, and better color range than an analog broadcast format, such as National Television System Committee (NTSC) or Phase Alternating Line (PAL), used to air the episode on broadcast television.

However, original film copies of some legacy video content can be missing, damaged, or otherwise unavailable. For example, a film master could be unavailable for certain episodes of an older television show or a specific segment within an episode of the older television show. In these types of situations, the legacy video content is typically only available in the analog broadcast format that is noticeably lower in resolution, color range, and visual quality than digital scans of the original film masters. While conventional image enhancement tools or techniques can be used to somewhat improve the quality of the legacy video content in the analog broadcast format, there can still be a perceptible difference in image quality between a remastered version of legacy video content that is produced by scanning the film master and a remastered version of legacy video content that is produced by applying these conventional image enhancement tools or techniques to a copy of the legacy video content in an analog broadcast format.

As the foregoing illustrates, what is needed in the art are more effective techniques for remastering video content.

### SUMMARY

One embodiment of the present invention sets forth a technique for performing remastering of video content. The technique includes determining a first input frame corresponding to a first frame included in a first video and a first target frame corresponding to a second frame included in a second video based on one or more alignments between the first frame and the second frame. The technique also includes executing a machine learning model to convert the first input frame into a first output frame. The technique further includes training the machine learning model based on one or more losses associated with the first output frame and the first target frame.

One technical advantage of the disclosed techniques relative to the prior art is that the machine learning model is trained to learn a mapping between a lower quality representation of video content and a higher quality representation of the same video content. This mapping allows the trained machine learning model to convert additional lower quality video content into a higher quality version that is visually and stylistically consistent with the higher quality representations of video content with which the machine learning model was trained. Consequently, the machine learning model can be used to remaster lower quality video content that lacks a master copy to the same visual quality as related video content that is remastered from the corresponding master copies, in contrast to conventional techniques that rely on standard image enhancement tools to improve the visual quality of legacy video content. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 is a more detailed illustration of the training engine and execution engine of FIG. 1, according to various embodiments.

FIG. 3 is an example architecture for the machine learning model of FIG. 2, according to various embodiments.

FIG. 4 is a flow diagram of method steps for generating an image enhancement machine learning model, according to various embodiments.

FIG. 5 is a flow diagram of method steps for performing image enhancement of video frames, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

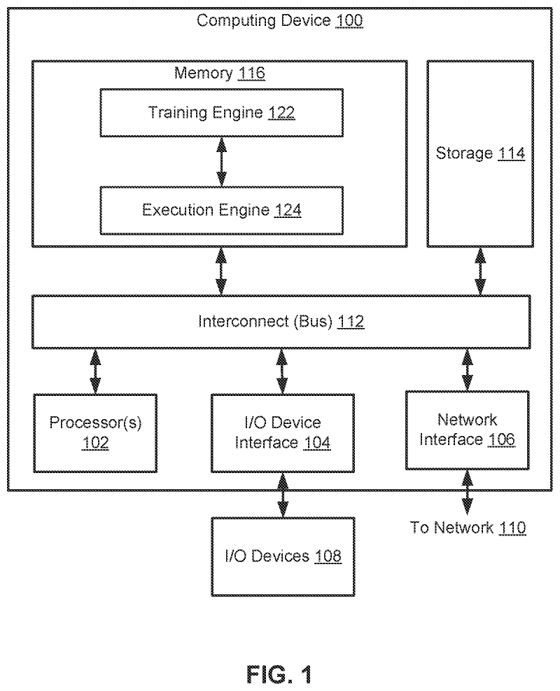

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in a memory 116.

It is noted that the computing device described herein is illustrative and that any other technically feasible configurations fall within the scope of the present disclosure. For example, multiple instances of training engine 122 and execution engine 124 could execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and execution engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In some embodiments, training engine 122 trains a machine learning model to perform image enhancement of frames in video content. More specifically, training engine 122 trains the machine learning model using corresponding paired frames from different versions of the same video content. For example, each pair of frames could include a first frame from a “lower quality” version of a piece of video content (e.g., an analog broadcast format used to air a television show) and a second frame from a “higher quality” version of the same piece of video content (e.g., a high-resolution scan of an original film master for the television show). For each pair of frames, the machine learning model is trained to reconstruct the higher quality version of the video content depicted in the second frame, given input that includes the lower quality version of the same video content depicted in the first frame. Consequently, the machine learning model learns a mapping from visual attributes of the lower quality version of the video content to visual attributes of the higher quality version of the video content.

Execution engine 124 executes one or more portions of the trained machine learning model to convert additional “lower quality” versions of video content into “higher quality” versions of the same video content. Continuing with the above example, execution engine 124 could input video frames from an analog broadcast version of an episode of a television show for which the film master is damaged or missing into the machine learning model. Execution engine 124 could use the machine learning model to convert the inputted video frames into output video frames that are visually and stylistically consistent with high-resolution scans of film masters for other episodes of the same television show and/or other television shows from the same time period. Consequently, the trained machine learning model can be used to perform high fidelity remastering of portions of video content for which the master copies are no longer available.

### Video Remastering Via Deep Learning

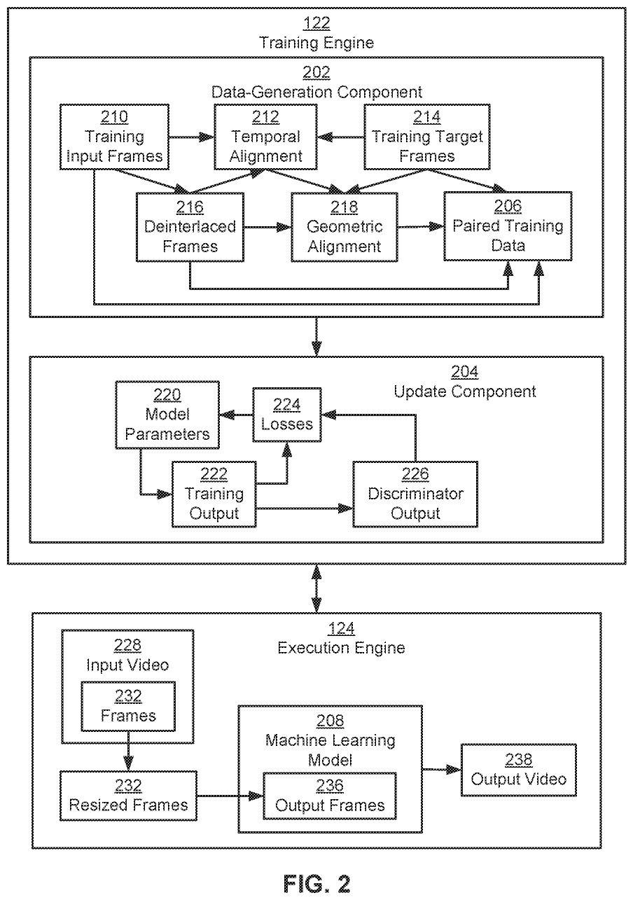

FIG. 2 is a more detailed illustration of training engine 122 and execution engine 124 of FIG. 1, according to various embodiments. As mentioned above, training engine 122 and execution engine 124 operate to train and execute a machine learning model 208 to remaster video content. For example, training engine 122 and execution engine 124 could be used to generate and execute an “image enhancement” or “image restoration” machine learning model 208 that is capable of improving the subjective and/or objective visual quality of frames from a video, even in the absence of a master copy of the video.

The operation of machine learning model 208 can be represented using the following:

I*=G(Iₗ|θ_{g}) (1)

In the above equation, machine learning model 208 is denoted by G with parameters θ_{g}. Given low-quality input Iₗ, machine learning model 208 generates a corresponding high-quality frame denoted by I*. For example, Iₗ could include an input frame from an analog broadcast version of an episode of a television show, and I* could include an output frame that depicts the same content as the input frame but at a higher resolution, visual quality, and/or color range than the input frame and/or at a lower noise level or distortion level than the input frame.

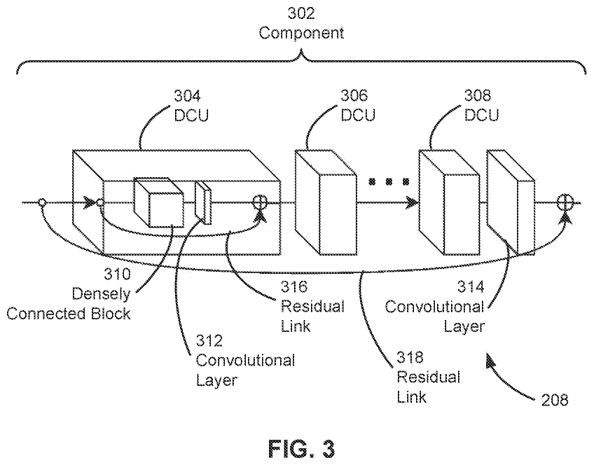

In some embodiments, machine learning model 208 includes multiple levels of dense compression units that decompose an image enhancement task into a series of simpler functions. Each level performs a different function and is responsible for refining the corresponding feature representation. As described in further detail below with respect to FIG. 3, each level includes a series of dense compression units (DCUs) and a number of residual links. Machine learning model 208 can also include a pixel shuffle layer that is applied to the input Iₗ.

As shown in FIG. 2, training engine 122 trains machine learning model 208 using paired training data 206 that is generated from a set of training input frames 210 and a set of training target frames 214. Training input frames 210 include frames from video content that is stored or represented in a first format, and training target frames 214 include frames from video content that is stored or represented in a second format.

In one or more embodiments, training input frames 210 and training target frames 214 are generated from the same source video content, but the depiction of the video content in training input frames 210 is lower in visual quality than the depiction of the video content in training target frames 214. For example, training input frames 210 could include interlaced and/or progressive frames that are extracted from analog versions of one or more episodes of a television show. Training target frames 214 could include progressive frames that are generated by scanning film masters of the same episode(s). Consequently, training input frames 210 could be associated with lower resolution, more blurriness, more noise, more distortion, lower color range, and/or other indicators of lower subjective or objective visual quality than the corresponding training target frames 214.

A data-generation component 202 in training engine 122 generates paired training data 206 from training input frames 210 and training target frames 214. First, data-generation component 202 converts training input frames 210 that are in an interlaced format into a corresponding set of deinterlaced frames 216. For example, data-generation component 202 could retrieve an interlaced video frame from the set of training input frames 210. Data-generation component 202 could also use an inverse telecine technique, a deep learning model, and/or another technique to convert odd-numbered scan lines and even-numbered scan lines from the interlaced video frame into two separate progressive video frames representing different points in time within the corresponding video. This deinterlacing step can be omitted for any training input frames 210 that correspond to progressive video frames.

Data-generation component 202 also performs temporal alignment 212 between training input frames 210 (or corresponding deinterlaced frames 216) and training target frames 214. In some embodiments, temporal alignment 212 is used to identify, for a first frame from training input frames 210 (or deinterlaced frames 216), a second frame from training target frames 214 that depicts the same content and/or depicts content that is closest to that of the first frame. For example, data-generation component 202 could perform temporal alignment 212 by determining a fixed temporal offset between a given sequence of progressive training input frames 210 (or corresponding deinterlaced frames 216) from a first video and a corresponding sequence of progressive training target frames 214 from a second video. Data-generation component 202 could also determine different temporal offsets for sequences corresponding to different shots, scenes, and/or other subsets of the first video and/or second video.

In another example, data-generation component 202 could compute a cost matrix [symbol] ∈≤ [symbol] ^{N}^{₁}^{×N}^{₂} that characterizes similarity between a sequence of N₁ training input frames 210 and a sequence of N₂ training target frames 214. Each entry cⱼₖ in the cost matrix could specify a numeric cost associated with temporal alignment 212 of a pair of frames (v₁(j), v₂(k)), where v₁ represents the sequence of training input frames 210, v₂ represents the sequence of training target frames 214, j is an index into a first frame in the sequence of training input frames 210, and k is an index into a second frame in the sequence of training target frames 214. The numeric cost could be computed based on an affinity histogram generated from matches between scale-invariant feature transform (SIFT) features (or other types of features extracted via feature descriptors) extracted from training input frames 210 and training target frames 214. Data-generation component 202 could then determine a pairwise temporal alignment 212 between some or all frames in training input frames 210 and some or all frames in training target frames 214 as a lowest cost “path” through the cost matrix. This path additionally allows temporal alignment 212 to reflect nonlinear variations in the speed or timing of content in training input frames 210 and/or training target frames 214.

After temporal alignment 212 is established between training input frames 210 (or corresponding deinterlaced frames 216) and training target frames 214, data-generation component 202 performs geometric alignment 218 between training input frames 210 (or deinterlaced frames 216) and the corresponding temporally aligned training target frames 214. In some embodiments, geometric alignment 218 is determined based on spatial correspondences between pixels or other portions of a first frame from training input frames 210 (or deinterlaced frames 216) and a second frame from training target frames 214 that has been temporally aligned with the first frame. For example, data-generation component 202 could compute a set of sparse spatial correspondences between a first set of key points in the first frame and a second set of key points in the second frame. Data-generation component 202 could use the sparse spatial correspondences to compute an affine transformation from the first frame to the second frame (or from the second frame to the first frame). Data-generation component 202 could apply the affine transformation to the first frame (or second frame) to generate a transformed first frame (or transformed second frame). Data-generation component 202 could use an optical flow estimation technique and/or another technique to compute a set of dense spatial correspondences between the transformed first frame (or transformed second frame) and the second frame (or first frame). Finally, data-generation component 202 could achieve full geometric alignment 218 by using the dense spatial correspondences to adjust pixel locations in the transformed first frame (or transformed second frame).

In another example, data-generation component 202 could use a deep learning model such as FlowNet, PWC-Net, and/or SpyNet to generate two-dimensional (2D) motion vectors representing optical flow between pixels in a first frame from training input frames 210 (or deinterlaced frames 216) and pixels in a second frame from training target frames 214 with which the first frame is temporally aligned. Data-generation component 202 could use the motion vectors to move pixels from the first frame (or the second frame) to the respective locations in the second frame (or the first frame), thereby generating a modified first frame (or modified second frame) that is geometrically aligned with the second frame (or first frame). Data-generation component 202 could also, or instead, use the deep learning model to convert the first frame (or second frame) into the modified first frame (or modified second frame) based on input that includes both frames.

Data-generation component 202 then generates paired training data 206 that includes pairs of frames selected from progressive training input frames 210 (or deinterlaced frames 216 generated from interlaced training input frames 210) and training target frames 214. Each pair of frames includes a first frame selected from training input frames 210 (or deinterlaced frames 216) and a second frame selected from training target frames 214. The first frame and second frame can be matched to one another based on temporal alignment 212 between training input frames 210 and training target frames 214. The first frame and/or second frame can also include a modified version of the corresponding training input frame and/or training target frame that is geometrically aligned with the other frame in the pair.

After paired training data 206 is generated, an update component 204 in training engine 122 uses paired training data 206 to train machine learning model 208. More specifically, update component 204 inputs progressive training input frames 210 and/or deinterlaced frames 216 from paired training data 206 into machine learning model 208. For each frame inputted into machine learning model 208, update component 204 obtains corresponding training output 222 that corresponds to a modified version of the inputted frame. Update component 204 computes one more losses 224 between each frame of training output 222 and a corresponding training target frame paired with the inputted frame. Update component 204 then uses a training technique (e.g., gradient descent and backpropagation) to update model parameters 220 of machine learning model 208 in a way that reduces losses 224. Update component 204 repeats the process with additional paired training data 206 and/over a certain number of training epochs and/or iterations until losses 224 fall below a threshold and/or another condition is met.

In one or more embodiments, losses 224 include an FFT-based loss [symbol] _{ƒƒt} that is computed as the L1 loss between a Fast Fourier Transform (FFT) decomposition F_{ƒƒt} of training output 222 represented by G(Iₗ) and a FFT decomposition of the corresponding training target frame I:

[symbol]

_{ƒƒt}= [symbol] ₁(F_{ƒƒt}(G(Iₗ)),F_{ƒƒt}(I) (2)

This FFT-based loss allows machine learning model 208 to learn to generate training output 222 with lower frequency noise, graininess, or other frequency-based artifacts than a corresponding machine learning model that is trained using a loss that is computed directly from pixel values in training output 222 and the corresponding training target frames 214 in paired training data 206.

Losses 224 can also, or instead, include a perceptual loss Lₚ that is computed from a first set of features associated with training output 222 and a second set of features associated with the corresponding training target frame:

Lₚ=Σᵢ∥Φᵢ(G(Iₗ))−Φᵢ(I)∥² (3)

In the above equation, Lₚ represents the perceptual loss, and Φᵢ is the ith block of a pre-trained feature extractor. This pre-trained feature extractor can include a VGG, ResNet, Inception, MobileNet, DarkNet, AlexNet, GoogLeNet, and/or another type of deep learning model that is trained to perform image classification, object detection, and/or other tasks related to the content in a large dataset of images.

One or more losses 224 are also, or instead, computed based on discriminator output 226 from a discriminator model (not shown). The discriminator model includes a neural network and/or another machine learning model that learns to discriminate between “real” high-quality frames (e.g., training target frames 214 generated via high-resolution scans of film masters) and “fake” high-quality frames (e.g., frames generated as training output 222 by machine learning model 208 from lower-quality input frames). In some embodiments, the discriminator model include the same number of levels as machine learning model 208 and operates on the residual outputs of each level.

The discriminator model can also be trained using the following discriminator loss [symbol] _{d}:

[symbol]

_{d}=D(G(Iₗ))²(D(I)−1)² (4)

In the above equation, D represents the discriminator model, which generates an output of 1 if the discriminator model determines that a corresponding input is a real high-quality frame and an output of 0 if the discriminator model determines that a corresponding input is a fake high-quality frame. D(G(Iₗ)) represents the probability that the discriminator model inaccurately classifies training output 222 G(Iₗ) as a real high-quality frame, and D(I) represents the probability that the discriminator model accurately identifies a real high-quality frame.

In some embodiments, machine learning model 208 is trained by incorporating discriminator output 226 into the following overall loss [symbol] ₒ:

[symbol]

ₒ= [symbol] _{ƒƒt}+λ₁(D(G(Iₗ))−1)²+λ₂Lₚ (5)

More specifically, machine learning model 208 can be trained using a weighted combination of the FFT-based loss represented by Equation 2, the perceptual loss represented by Equation 3, and a generator loss term [symbol] _{g}=(D(G(Iₗ))−1)² that is minimized when the discriminator model incorrectly classifies training output 222 G(Iₗ) as a real high-quality frame. Weights used in the weighted combination are represented by λ₁ and λ₂ and can be adjusted to reflect the contribution of the corresponding loss terms to the overall loss. For example, λ₁ could be set to a higher value than λ₂ to increase the contribution of discriminator output 226 to the training of machine learning model 208. In another example, λ₁ and/or λ₂ could be increased or decreased with respect to 1 to adjust the relative contribution of the FFT-based loss to the overall generator loss.

During training of machine learning model 208, update component 204 also trains the discriminator model in an adversarial fashion with machine learning model 208. For example, update component 204 could initially train machine learning model 208 in a way that minimizes the overall loss represented by Equation 5 and/or another loss that incorporates discriminator output 226 from the discriminator model. Training engine 122 could subsequently train the discriminator model in a way that maximizes the discriminator loss represented by Equation 4. Training engine 122 could then train both machine learning model 208 and the discriminator model in a way that minimizes the discriminator loss and/or overall loss for machine learning model 208 and maximizes the discriminator loss for the discriminator model.

In one or more embodiments, update component 204 trains machine learning model 208 over multiple stages using different losses 224 for each stage. For example, update component 204 could perform a first training stage that trains machine learning model 208 using the FFT-based L1 loss represented by Equation 2. After a certain number of optimization steps, epochs, and/or iterations, update component 204 could perform a second training stage that trains machine learning model 208 using the overall loss represented by Equation 5.

While the operation of training engine 122 has been described above with certain losses 224 and/or training stages, it will be appreciated that machine learning model 208 can be trained using various losses, combinations of losses, and/or combinations of training stages. For example, training engine 122 could train machine learning model 208 and/or the discriminator model using various combinations of the FFT-based loss, perceptual loss, generator losses, discriminator losses, and/or other losses associated with training output 222 and/or discriminator output 226. In another example, training engine 122 could perform one or more additional training stages to train machine learning model 208 and/or the discriminator model using a series of different losses 224. In a third example, training engine 122 could train machine learning model 208 using one or more style losses 224 and/or one or more content losses 224 computed between feature maps associated with training output 222, content samples derived from training input frames 210 and/or deinterlaced frames 216, and style samples derived from training target frames 214. In a fourth example, training engine 122 could train machine learning model 208 using a mean squared error (MSE), cross entropy loss, L2 loss, and/or another type of reconstruction loss between training output 222 (or frequency domain representations of training output 222) and the corresponding representations of training target frames 214 (or frequency domain representations of training target frames 214) in paired training data 206.

After training of machine learning model 208 is complete, execution engine 124 uses the trained machine learning model 208 to convert frames 232 from an input video 228 into corresponding output frames 236 with the desired visual attributes. For example, execution engine 124 could retrieve one or more frames 232 from input video 228 in an analog broadcast format that lacks a film master. Execution engine 124 could input frames 232 into machine learning model 208 and use machine learning model 208 to convert input frames 232 into corresponding output frames 236. Each output frame could depict the same content as the corresponding input frame but at a higher visual quality (e.g., higher resolution, higher color range, less blurriness, less distortion, less noise, etc.) than the input frame.

As shown in FIG. 2, execution engine 124 can convert frames 232 from input video 228 into resized frames 232 of a different size or resolution. For example, execution engine 124 could use upscaling and/or deep learning techniques to convert each of frames 232 into a corresponding resized frame with a resolution that matches a desired output resolution (e.g., a resolution with which a higher quality version of input video 228 is to be streamed). Execution engine 124 can use resized frames 232 as input into machine learning model 208 in lieu of the original frames 232, thereby causing machine learning model 208 to generate output frames 236 of the same resolution as resized frames 232.

In one or more embodiments, some or all frames 232 from input video 228 are selected based on similarity to one or more sets of training input frames 210 with which machine learning model 208 was trained. For example, frames 232 could be extracted from input video 228 in the same analog broadcast format as training input frames 210 used to train machine learning model 208.

In another example, machine learning model 208 could be trained using paired training data 206 that includes one or more segments of lower quality training input frames 210 from an episode of a television show and one or more segments of higher quality training target frames 214 that have been temporally and geometrically aligned with the lower quality input frames 210. After training of machine learning model 208 is complete, the trained machine learning model 208 could be used to convert low quality frames 232 from one or more additional segments of video content from the same episode into higher quality output frames 236. The resolution, sharpness, color range, levels of noise, levels of distortion, and/or other visual attributes of the higher quality output frames 236 would be similar to those of the higher quality training target frames 214 with which machine learning model 208 was trained.

In a third example, machine learning model 208 could be trained using paired training data 206 that includes lower quality training input frames 210 and corresponding higher quality training target frames 214 from one or more television shows with a similar “style” (e.g., television shows from the same time period and/or genre). After training of machine learning model 208 is complete, the trained machine learning model 208 could be used to convert low quality frames 232 from additional episodes of the same television shows and/or one or more episodes of other television shows with the same style into corresponding higher quality output frames 236.

In a fourth example, multiple versions of machine learning model 208 could be trained using paired training data 206 from different groupings of video content (e.g., television shows, movies, user-generated content, etc.). These groupings could include shots, scenes, episodes, or other subsets of video content associated with different genres, time periods, locations, production companies, directors, cinematographers, actors, recording media (e.g., different types of film or digital cameras), or other attributes that are relevant to the style or substance of the video content. To enhance a given input video 228, execution engine 124 could divide input video 228 into individual frames 232, sequences of frames 232 corresponding to individual shots, scenes, or locations in input video 228, and/or other subsets of input video 228. For each subset of input video 228, execution engine 124 could match metadata for the subset, pixel values included in the subset, embeddings or encodings of frames 232 or pixel value within the subset, objects identified in the subset, and/or other attributes associated with that subset to corresponding attributes for a grouping of video content with which a given version of machine learning model 208 was trained. Execution engine 124 could then use that version of machine learning model 208 to convert frames 232 within the subset into corresponding output frames 236. Execution engine 124 could also, or instead, match attributes associated with the entire input video 228 to corresponding attributes for a grouping of video content with which a given version of machine learning model 208 was trained and use that version of machine learning model 208 to convert frames 232 in input video 228 into corresponding output frames 236.

Execution engine 124 can also generate an output video 238 that includes output frames 236. For example, execution engine 124 could generate a sequence of output frames 236 that reflects the sequence of corresponding frames 232 in input video 228. Execution engine 124 could also generate output video 238 by encoding output frames 236 in the desired format, generating additional output frames 236 by interpolating between output frames 236 produced by machine learning model 208, and/or performing other types of processing or enhancement related to output frames 236.

FIG. 3 is an example architecture for machine learning model 208 of FIG. 2, according to various embodiments. As mentioned above, machine learning model 208 can include an “image enhancement” or “image restoration” model that is used to improve the subjective and/or objective visual quality of frames from a video, even in the absence of a master copy of the video.

As shown, the architecture includes a component 302 that is composed of a sequence of dense compression units (DCUs) 304, 306, 308 (hereinafter collectively referred to as “DCUs 304-308”) followed by a convolutional layer 314. Multiple instances of component 302 can be used in multiple levels of machine learning model 208, and each level can be adapted to a specific function within an overall image enhancement task performed by machine learning model 208.

As illustrated with respect to DCU 304, each of DCUs 304-308 includes a densely connected block 310 followed by a convolutional layer 312. Densely connected block 310 includes a series of densely connected layers, where input to each layer in the series includes the output of all previous layers in the series. Each layer in densely connected block 310 is additionally composed of a combination of convolutional layers and activation functions, such as CONV(1,1)-RELU-CONV(3,3). Alternative versions of densely connected layers in densely connected block 310 may include batch normalization and/or other types of layers. For example, one or more densely connected layers in densely connected block 310 could be composed of BN-RELU-CONV(1,1)-RELU-CONV(3,3).

Convolutional layer 312 can be used to break dense connections between layers in densely connected block 310. For example, convolutional layer 312 could include a CONV(1,1) compression layer to reduce the dimensionality of the output of densely connected block 310.

Convolutional layer 314 may be used to convert the output of the final DCU 308 into the output of component 302. For example, convolutional layer 314 could include a sub-pixel CONV(3,3) that upscales the feature map from the final layer of DCU 308 into the output of machine learning model 208.

The architecture additionally includes a residual link 316 that adds the input of each DCU to the output of the same DCU, as well as a residual link 318 that adds the input to component 302 to the output of convolutional layer 314. Residual links 316 and 318 can be used to improve the propagation of errors and/or gradients across layers of component 302 and/or machine learning model 208.

As mentioned above, a discriminator model can include the same number of levels as machine learning model 208 and be applied to the residual outputs of each level. For example, a given level of the discriminator model could be used to classify one or more residuals outputted by a corresponding level of machine learning model 208 as real or fake. As a result, one or more losses 224 (e.g., the generator loss from Equation 5 and/or the discriminator loss of Equation 4) can be computed based on the output generated by a given level of the discriminator model from residual output at a corresponding level of machine learning model 208. The per-level losses 224 can also be averaged or otherwise aggregated to produce an overall set of losses 224 with which machine learning model 208 and/or the discriminator model are trained.

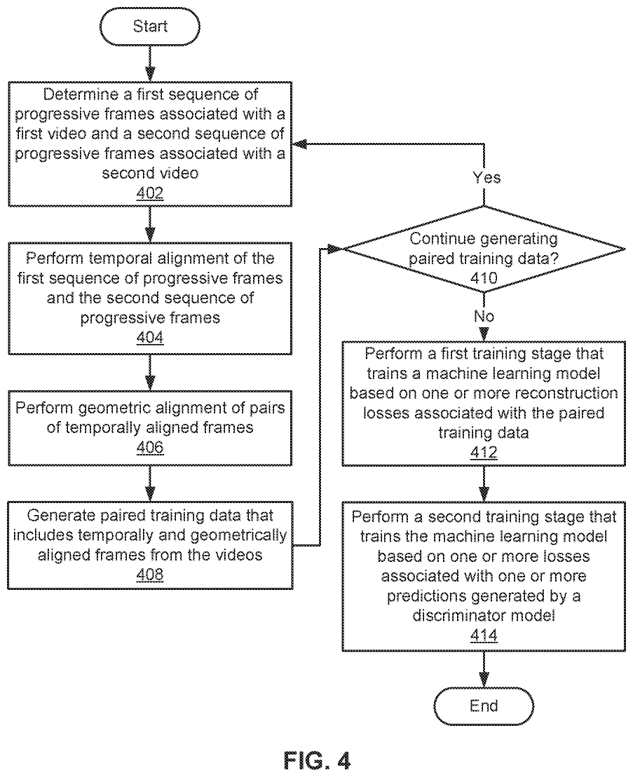

FIG. 4 is a flow diagram of method steps for generating an image enhancement machine learning model, according to various embodiments. Although the method steps are described in conjunction with the systems of FIGS. 1-2, persons skilled in the art will understand that any system configured to perform the method steps in any order falls within the scope of the present disclosure.

As shown, in step 402, training engine 122 determines a first sequence of progressive frames associated with a first video and a second sequence of progressive frames associated with a second video. For example, training engine 122 could extract the first sequence of progressive frames from the first video and the second sequence of progressive frames from the second video. In another example, training engine 122 could use a deinterlacing technique and/or deinterlacing deep learning model to convert a sequence of interlaced frames in the first video into the first sequence of progressive frames. The first video could include a format that is lower in visual quality than the second video.

In step 404, training engine 122 performs temporal alignment of the first sequence of progressive frames and the second sequence of progressive frames. For example, training engine 122 could use deep learning techniques, feature matching techniques, and/or other techniques to determine a fixed or varying offset between frames in the first sequence and frames in the second sequence.

In step 406, training engine 122 performs geometric alignment of pairs of temporally aligned frames. For example, training engine 122 could use an edge-, blob-, corner-, or feature-detection technique to identify a first set of key points in a first frame and a second set of key points in a second frame that is temporally aligned with the first frame. Training engine 122 could compute a set of sparse spatial correspondences between the first set of key points in the first frame and the second set of key points in the second frame. Training engine 122 could use the sparse spatial correspondences to compute an affine transformation from the first frame to the second frame (or from the second frame to the first frame). Training engine 122 could apply the affine transformation to the first frame (or second frame) to generate a transformed first frame (or transformed second frame). Training engine 122 could use an optical flow estimation technique and/or another type of flow estimation technique to compute a set of dense spatial correspondences between the transformed first frame (or transformed second frame) and the second frame (or first frame). Finally, training engine 122 could use the dense spatial correspondences to adjust pixel locations in the transformed first frame (or transformed second frame). Step 406 can be omitted if pairs of temporally aligned frames from the two videos are already geometrically aligned or have a known “fixed” geometric relationship with one another.

In step 408, training engine 122 generates paired training data that includes temporally and geometrically aligned frames from the videos. For example, training engine 122 could add pairs of temporally and geometric aligned frames to the paired training data. Each pair could include a first frame that depicts content from the first video and a second frame that depicts content from the second video. The first frame and second frame could be temporally aligned with one another, and pixel locations in the first frame and second frame could be geometrically aligned with one another.

In step 410, training engine 122 determines whether or not to continue generating paired training data. For example, training engine 122 could determine that additional paired training data is to be generated from additional sequences of lower quality video that can be temporally and geometrically aligned with corresponding sequences of higher quality video. Training engine 122 could also, or instead, determine that additional paired training data is to be generated using sequences of video from additional scenes and/or episodes of a television show that includes the first video and second video. Training engine 122 could also, or instead, determine that additional paired training data is to be generated using sequences of video from a different television show with a similar style or genre to that of the first video or second video. It will be appreciated that the generation of paired training data from video content in television shows is a non-limiting example, and that other types of video content (e.g., movies, user-generated content, procedurally generated video content, rendered video content, etc.) can also be used to generate paired training data.

If training engine 122 determines that additional paired training data is to be generated, training engine 122 repeats steps 402, 404, 406, and 408 for additional sequences of temporally and/or geometrically aligned frames from different versions of the same video content. Training engine 122 stops performing steps 402, 404, 406, and 408 once training engine 122 determines that no additional paired training data is to be generated (e.g., after all temporally and geometrically aligned frames in pairs of videos with which the machine learning model is to be trained have been included in the paired training data).

After paired training data is generated using steps 402, 404, 406, 408, and 410, training engine 122 performs step 412, in which training engine 122 performs a first training stage that trains a machine learning model based on one or more reconstruction losses associated with the paired training data. For example, training engine 122 could input a first frame from each pair of frames in the paired training data into the machine learning model. For each inputted frame, training engine 122 could obtain a corresponding training output frame from the machine learning model. Training engine 122 could compute an L1 loss between FFT decompositions of the inputted and outputted frames. Training engine 122 could also, or instead, compute another type of reconstruction loss between the FFT decompositions, pixel values in the inputted and outputted frames, and/or other representations of the inputted and outputted frames. Training engine 122 could then use a training technique (e.g., gradient descent and backpropagation) to update model parameters of the machine learning model in a way that reduces the loss(es).

In step 414, training engine 122 performs a second training stage that trains the machine learning model based on one or more losses associated with one or more predictions generated by a discriminator model. For example, training engine 122 could use the discriminator model to generate predictions that classify training output frames generated by the machine learning model as real or fake. Training engine 122 could compute a generator loss using predictions generated by the discriminator model and update parameters of the machine learning model in a way that reduces the generator loss. Training engine 122 could also compute a discriminator loss using the predictions and update parameters of the machine learning model in a way that reduces the discriminator loss.

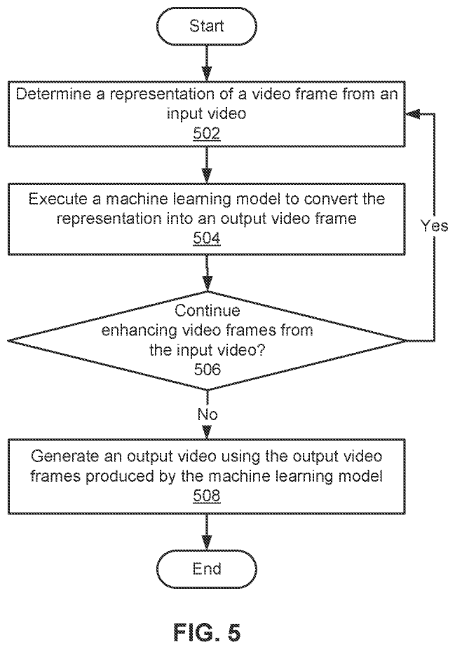

FIG. 5 is a flow diagram of method steps for performing image enhancement of video frames, according to various embodiments. Although the method steps are described in conjunction with the systems of FIGS. 1-2, persons skilled in the art will understand that any system configured to perform the method steps in any order falls within the scope of the present disclosure.

As shown, in step 502, execution engine 124 determines a representation of a video frame from an input video. For example, execution engine 124 could retrieve the video frame from a shot, scene, episode, or another portion of a television show, movie, or another type of video content. Execution engine 124 could use pixel values from the video frame as the representation of the video frame. Execution engine 124 could also, or instead, use upscaling and/or deep learning techniques to convert the video frame into a corresponding resized frame with a resolution that matches a desired output resolution and use the resized frame as the representation of the video frame.

In step 504, execution engine 124 executes a machine learning model to convert the representation into an output video frame. For example, execution engine 124 could select a version of the machine learning model that was trained to enhance video content that is similar to that of the input video and/or video frame. Execution engine 124 could also use the machine learning model to convert a lower quality depiction of content in the representation into a higher quality depiction of the same content in the output video frame.

In step 506, execution engine 124 determines whether or not to continue enhancing video frames from the input video. For example, execution engine 124 could continue enhancing video frames from the input video if the machine learning model has not yet been used to generate higher quality output video frames for all video frames in the input video. While execution engine 124 determines that enhancement of video frames is to continue, execution engine 124 repeats steps 502 and 504 to convert representations of remaining video frames from the input video into corresponding output video frames. Execution engine 124 stops using the machine learning model to enhance video frames from the input video after all video frames in the input video have been converted into higher quality output video frame.

In step 508, execution engine 124 generates an output video using the output video frames produced by the machine learning model. For example, execution engine 124 could assemble higher quality output video frames produced by the machine learning model into a “remastered” version of the shot, scene, episode, or another portion of video content represented by the input video. Execution engine 124 could also, or instead, perform additional processing on the higher quality frames (e.g., color correction, sharpening, interpolation, etc.) to generate the remastered version of the input video.

In sum, the disclosed techniques train and execute a machine learning model to enhance video content in a way that is visually similar to standard remastering techniques that are used with master copies of the video content. The machine learning model is trained using paired training data that is generated from two different versions of the same video content. The first version includes a lower quality representation of the video content, and the second version includes a higher quality representation of the video content. For example, the first version could include an analog broadcast version or low-resolution digital version of an episode of a television show, and the second version could include a high-resolution scan of a film master for the same episode. The paired training data includes multiple pairs of frames, where each pair of frames includes a first frame from the first version and a second frame from the second version. A given pair of frames is generated by establishing temporal alignment of the first frame with the second frame and subsequently performing geometric alignment of pixel values in the first and second frames.

The machine learning model is trained to generate higher quality frames in the paired training data, given input that includes the corresponding lower quality frames. During a first training stage, the machine learning model is trained in a way that minimizes a loss computed from FFT decompositions of output frames generated by the machine learning model from the inputted lower quality frames and FFT decompositions of the corresponding higher quality frames. After the first training stage is complete, the machine learning model is trained in conjunction with a discriminator model that attempts to distinguish between the output frames produced by the machine learning model and the higher quality frames.

One technical advantage of the disclosed techniques relative to the prior art is that the machine learning model is trained to learn a mapping between a lower quality representation of video content and a higher quality representation of the same video content. This mapping allows the trained machine learning model to convert additional lower quality video content into a higher quality version that is visually and stylistically consistent with the higher quality representations of video content with which the machine learning model was trained. Consequently, the machine learning model can be used to remaster lower quality video content that lacks a master copy to the same visual quality as related video content that is remastered from the corresponding master copies, in contrast to conventional techniques that rely on standard image enhancement tools to improve the visual quality of legacy video content. These technical advantages provide one or more technological improvements over prior art approaches.

1. In some embodiments, a computer-implemented method for performing remastering of video content comprises determining a first input frame corresponding to a first frame included in a first video and a first target frame corresponding to a second frame included in a second video based on one or more alignments between the first frame and the second frame; executing a machine learning model to convert the first input frame into a first output frame; and training the machine learning model based on one or more losses associated with the first output frame and the first target frame.

2. The computer-implemented method of clause 1, further comprising executing the machine learning model to convert a second input frame included in a third video into a second output frame.

3. The computer-implemented method of any of clauses 1-2, further comprising executing a discriminator model to generate a prediction associated with the second output frame; and training the machine learning model based on one or more additional losses associated with the prediction.

4. The computer-implemented method of any of clauses 1-3, further comprising generating a first set of feature maps associated with the second output frame; and training the machine learning model based on a perceptual loss computed between the first set of feature maps and a second set of feature maps associated with a second target frame included in a fourth video.

5. The computer-implemented method of any of clauses 1-4, wherein determining the first input frame comprises separating the first frame into a first set of scan lines and a second set of scan lines; and generating the first input frame from the first set of scan lines.

6. The computer-implemented method of any of clauses 1-5, wherein determining the first input frame and the first target frame comprises determining at least one of the first input frame or the first target frame based on a temporal alignment between the first frame and the second frame.

7. The computer-implemented method of any of clauses 1-6, wherein determining the first input frame and the first target frame comprises generating at least one of the first input frame or the first target frame based on a geometric alignment between the first frame and the second frame.

8. The computer-implemented method of any of clauses 1-7, wherein determining the first input frame comprises resizing the first frame.

9. The computer-implemented method of any of clauses 1-8, wherein the one or more losses are computed based on a first Fast Fourier Transform (FFT) decomposition of the first output frame and a second FFT decomposition of the first target frame.

10. The computer-implemented method of any of clauses 1-9, wherein the one or more losses comprise an L1 loss.

11. In some embodiments, one or more non-transitory computer-readable media store instructions that, when executed by one or more processors, cause the one or more processors to perform the steps of determining a first input frame corresponding to a first frame included in a first video and a first target frame corresponding to a second frame included in a second video based on one or more alignments between the first frame and the second frame; executing a machine learning model to convert the first input frame into a first output frame; and training the machine learning model based on one or more losses associated with the first output frame and the first target frame.

12. The one or more non-transitory computer-readable media of clause 11, wherein the instructions further cause the one or more processors to perform the steps of executing the machine learning model to convert a second input frame included in a third video into a second output frame; executing a discriminator model to generate a first prediction associated with the second output frame; and training the machine learning model based on one or more additional losses associated with the first prediction.

13. The one or more non-transitory computer-readable media of any of clauses 11-12, wherein training the machine learning model based on the one or more losses and the one or more additional losses comprises performing a first training stage that trains the machine learning model based on the one or more losses; and after the first training stage is complete, performing a second training stage based on a combination of the one or more losses and the one or more additional losses.

14. The one or more non-transitory computer-readable media of any of clauses 11-13, wherein the one or more additional losses comprise a weighted combination of a first loss that is computed based on the second output frame a second loss that is computed based on the first prediction.

15. The one or more non-transitory computer-readable media of any of clauses 11-14, wherein the instructions further cause the one or more processors to perform the step of training the discriminator model based on a loss that is computed from the first prediction and a second prediction generated by the discriminator model from a second target frame associated with the second input frame.

16. The one or more non-transitory computer-readable media of any of clauses 11-15, wherein training the machine learning model comprises generating a first set of feature maps associated with the first output frame and a second set of feature maps associated with the first target frame; and training the machine learning model based on a perceptual loss computed between the first set of feature maps and the second set of feature maps.

17. The one or more non-transitory computer-readable media of any of clauses 11-16, wherein determining the first input frame and the first target frame comprises determining a temporal alignment between the first frame and the second frame; and generating at least one of the first input frame or the first target frame based on a geometric alignment between the first frame and the second frame.

18. The one or more non-transitory computer-readable media of any of clauses 11-17, wherein determining the first input frame comprises determining an affine transformation based on a first set of spatial correspondences between the first frame and the second frame; applying the affine transformation to the first frame to generate a transformed frame; and generating the first input frame based on a second set of spatial correspondences between the transformed frame and the second frame.

19. The one or more non-transitory computer-readable media of any of clauses 11-18, wherein the one or more losses comprise an L1 loss that is computed between a first Fast Fourier Transform (FFT) decomposition of the first output frame and a second FFT decomposition of the first target frame.

20. In some embodiments, a system comprises one or more memories that store instructions, and one or more processors that are coupled to the one or more memories and, when executing the instructions, are configured to perform the steps of determining a first input frame corresponding to a first frame included in a first video and a first target frame corresponding to a second frame included in a second video based a temporal alignment between the first frame and the second frame and a geometric alignment between the first frame and the second frame; executing a machine learning model to convert the first input frame into a first output frame; and training the machine learning model based on one or more losses associated with the first output frame and the first target frame.

21. In some embodiments, a computer-implemented method for performing remastering of video content comprises determining a first input frame corresponding to a first frame included in a first video, wherein the first input frame is associated with a first level of quality; executing a machine learning model to convert the first input frame into a first output frame, wherein the first output frame is associated with a second level of quality that is higher than the first level of quality, and wherein the machine learning model is trained using a set of input frames that is associated with the first level of quality and a set of target frames that is temporally aligned with the set of input frames and associated with the second level of quality; and generating a second video that includes the first output frame.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing remastering of video content, the computer-implemented method comprising:
determining a first input frame corresponding to a first frame included in a first video and a first target frame corresponding to a second frame included in a second video based on one or more alignments between the first frame and the second frame;
executing a machine learning model to convert the first input frame into a first output frame; and
training the machine learning model based on one or more losses associated with the first output frame and the first target frame.

2. The computer-implemented method of claim 1, further comprising executing the machine learning model to convert a second input frame included in a third video into a second output frame.

3. The computer-implemented method of claim 2, further comprising:
executing a discriminator model to generate a prediction associated with the second output frame; and
training the machine learning model based on one or more additional losses associated with the prediction.

4. The computer-implemented method of claim 2, further comprising:
generating a first set of feature maps associated with the second output frame; and
training the machine learning model based on a perceptual loss computed between the first set of feature maps and a second set of feature maps associated with a second target frame included in a fourth video.

5. The computer-implemented method of claim 1, wherein determining the first input frame comprises:
separating the first frame into a first set of scan lines and a second set of scan lines; and
generating the first input frame from the first set of scan lines.

6. The computer-implemented method of claim 1, wherein determining the first input frame and the first target frame comprises determining at least one of the first input frame or the first target frame based on a temporal alignment between the first frame and the second frame.

7. The computer-implemented method of claim 1, wherein determining the first input frame and the first target frame comprises generating at least one of the first input frame or the first target frame based on a geometric alignment between the first frame and the second frame.

8. The computer-implemented method of claim 1, wherein determining the first input frame comprises resizing the first frame.

9. The computer-implemented method of claim 1, wherein the one or more losses are computed based on a first Fast Fourier Transform (FFT) decomposition of the first output frame and a second FFT decomposition of the first target frame.

10. The computer-implemented method of claim 1, wherein the one or more losses comprise an L1 loss.

11. One or more non-transitory computer-readable media storing instructions that, when executed by one or more processors, cause the one or more processors to perform the steps of:
determining a first input frame corresponding to a first frame included in a first video and a first target frame corresponding to a second frame included in a second video based on one or more alignments between the first frame and the second frame;
executing a machine learning model to convert the first input frame into a first output frame; and
training the machine learning model based on one or more losses associated with the first output frame and the first target frame.

12. The one or more non-transitory computer-readable media of claim 11, wherein the instructions further cause the one or more processors to perform the steps of:
executing the machine learning model to convert a second input frame included in a third video into a second output frame;
executing a discriminator model to generate a first prediction associated with the second output frame; and
training the machine learning model based on one or more additional losses associated with the first prediction.

13. The one or more non-transitory computer-readable media of claim 12, wherein training the machine learning model based on the one or more losses and the one or more additional losses comprises:
performing a first training stage that trains the machine learning model based on the one or more losses; and
after the first training stage is complete, performing a second training stage based on a combination of the one or more losses and the one or more additional losses.

14. The one or more non-transitory computer-readable media of claim 12, wherein the one or more additional losses comprise a weighted combination of a first loss that is computed based on the second output frame a second loss that is computed based on the first prediction.

15. The one or more non-transitory computer-readable media of claim 12, wherein the instructions further cause the one or more processors to perform the step of training the discriminator model based on a loss that is computed from the first prediction and a second prediction generated by the discriminator model from a second target frame associated with the second input frame.

16. The one or more non-transitory computer-readable media of claim 11, wherein training the machine learning model comprises:
generating a first set of feature maps associated with the first output frame and a second set of feature maps associated with the first target frame; and
training the machine learning model based on a perceptual loss computed between the first set of feature maps and the second set of feature maps.

17. The one or more non-transitory computer-readable media of claim 11, wherein determining the first input frame and the first target frame comprises:
determining a temporal alignment between the first frame and the second frame; and
generating at least one of the first input frame or the first target frame based on a geometric alignment between the first frame and the second frame.

18. The one or more non-transitory computer-readable media of claim 11, wherein determining the first input frame comprises:
determining an affine transformation based on a first set of spatial correspondences between the first frame and the second frame;
applying the affine transformation to the first frame to generate a transformed frame; and
generating the first input frame based on a second set of spatial correspondences between the transformed frame and the second frame.

19. The one or more non-transitory computer-readable media of claim 11, wherein the one or more losses comprise an L1 loss that is computed between a first Fast Fourier Transform (FFT) decomposition of the first output frame and a second FFT decomposition of the first target frame.

20. A system, comprising:
one or more memories that store instructions, and
one or more processors that are coupled to the one or more memories and, when executing the instructions, are configured to perform the steps of:
determining a first input frame corresponding to a first frame included in a first video and a first target frame corresponding to a second frame included in a second video based a temporal alignment between the first frame and the second frame and a geometric alignment between the first frame and the second frame;
executing a machine learning model to convert the first input frame into a first output frame; and
training the machine learning model based on one or more losses associated with the first output frame and the first target frame.

21. A computer-implemented method for performing remastering of video content, the method comprising:
determining a first input frame corresponding to a first frame included in a first video, wherein the first input frame is associated with a first level of quality;
executing a machine learning model to convert the first input frame into a first output frame, wherein the first output frame is associated with a second level of quality that is higher than the first level of quality, and wherein the machine learning model is trained using a set of input frames that is associated with the first level of quality and a set of target frames that is temporally aligned with the set of input frames and associated with the second level of quality; and
generating a second video that includes the first output frame.
